(19) United States
(12) Patent Application Publication
(10) Pub. No.: US 2007/0015896 A1
(43) Pub. Date: Jan. 18, 2007

(54) Dihydroxy aramid polymers

(76) Inventor: Kiu-Seung Lee, Philadelphia, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/180,152

(22) Filed: Jul. 13, 2005

(51) Int. Cl. C08G 64/00

(52) U.S. Cl. 528/196

(57) ABSTRACT

The present invention relates to dihydroxy aramid polymers such as formed by contacting an aromatic diamine with an aromatic dihydroxy diacid dihalide.

### BACKGROUND

1. Field of the Invention

This invention is directed to dihydroxy aramid polymers useful for forming fibers and other articles.

2. Description of Related Art

Aramid polymers form planar sheet structures due to their rigid rod structure. The lack of interaction between these planar layers results in polymer sheets that lack compressive strength.

What is therefore needed are substituents on the aramid polymer to allow an interaction between the polymer layers.

U.S. Pat. No. 3,515,695 to Loughran et al. discloses the self-polymerization of dihydroxy terephthalic acid. The incorporation of a second monomer in the polymerization reaction is not taught.

U.S. Pat. No. 3,063,966 to Kwolek et al. discloses that the aromatic rings of the polymer can have substituents. The patent does not teach hydroxyl groups as substituents.

### BRIEF SUMMARY OF THE INVENTION

This invention relates to a dihydroxy aramid polymer containing repeating units of Formula I. 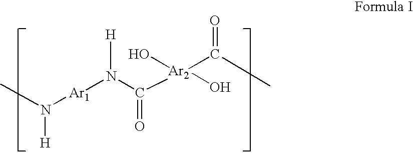
wherein Ar₁ and Ar₂ independently are wholly aromatic ring systems.

A preferred polymer of Formula I contains repeating units of Formula II.

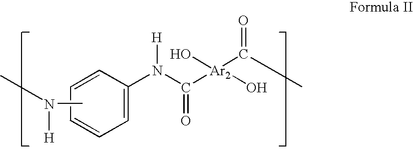

An example of a polymer within the scope of Formulas I and II contains repeating units of Formula III:

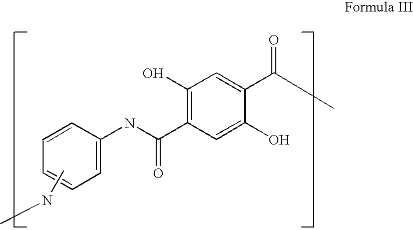

### DETAILED DESCRIPTION OF THE INVENTION

As set forth in the Brief Summary of The Invention, this invention is directed to dihydroxy aramid polymers of Formula I wherein Formulas II and III represent preferred embodiments of Formula I.

As set forth in the Summary, Ar₁ and Ar₂ independently represent aromatic ring systems. Preferred Ar₁ and Ar₂ contain naphthalenic or benzoic groups which are shown by structures (a) and (b):

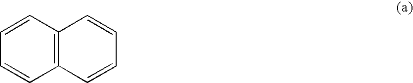

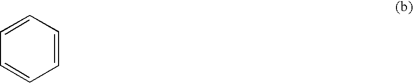

Preferably Ar₁ and Ar₂ are identical and more preferably both Ar₁ and Ar₂ represent a benzoic group.

Polymers including homopolymers and copolymers of Formula I can be formed by reaction of an aromatic dihydroxy diacid dihalide with an aromatic diamine.

For purposes herein, the term “aromatic dihydroxy diacid dihalide” includes chemical compounds of the structure: 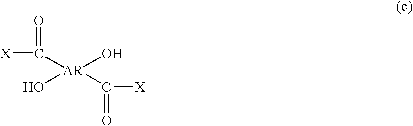
where AR is as defined in accordance with Ar₁ and Ar₂. However, acid halide groups (—CXO) are required to be ortho to a distinct hydroxyl group (—OH). Each X is independently a fluorine, chlorine, bromine, or iodine. Preferably, each X is independently chlorine or bromine. The preferred aromatic dihydroxy diacid dihalides are 1,5-dihydroxy-2,6-naphthaloyl (di)chloride, 2,6-dihydroxy-1,5-naphthaloyl (di)chloride or 2,5 dihydroxyterephthaloyl (di)chloride or mixtures thereof which are shown below by structures (d)-(f) respectively.

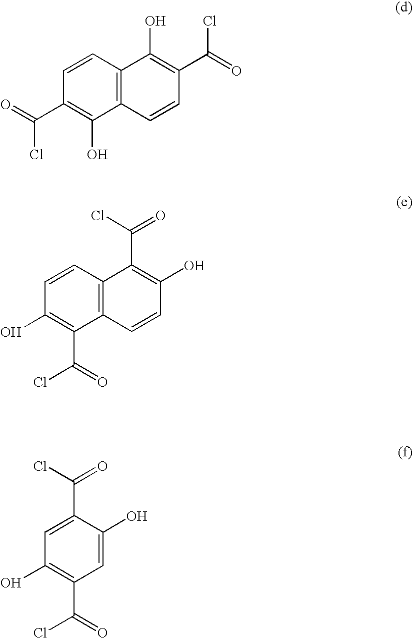

The aromatic dihydroxy diacid dihalide that is most preferred is 2,5 dihydroxyterephthaloyl(di)chloride.

An aromatic dihydroxy diacid dihalide can be formed by the steps of:
a) forming a solution of an aromatic dihydroxy diacid in a solvent with the proviso that the aromatic dihydroxy diacid dihalide formed in step (c) is soluble in the solvent;
b) contacting the aromatic dihydroxy diacid solution with a halogenating agent;
c) heating the solution under an inert atmosphere to convert at least a portion of the aromatic dihydroxy diacid to aromatic dihydroxy diacid dihalide; and
d) removing at least a portion of the solvent.

Method step (a) comprises forming a solution of an aromatic dihydroxy diacid in a solvent. The aromatic dihydroxy diacid is of the structure: 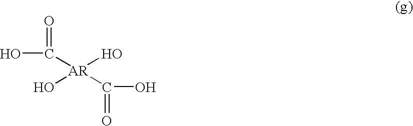
where AR is as defined previously, and the carboxylic acid groups are each ortho to a distinct hydroxyl group. Preferably, AR is a naphthalenic or benzoic group, wherein the benzoic group is the most preferred aromatic ring system.

The preferred aromatic dihydroxy diacids are 1,5-dihydroxy-2,6-naphthalene dicarboxylic acid, 2,6-dihydroxy-1,5-naphthalene dicarboxylic acid or 2,5 dihydroxyterephthalic acid which are shown below as structures (h)-(j). The most preferred benzoic aromatic dihydroxy diacid is 2,5-dihydroxyterephthalic acid.

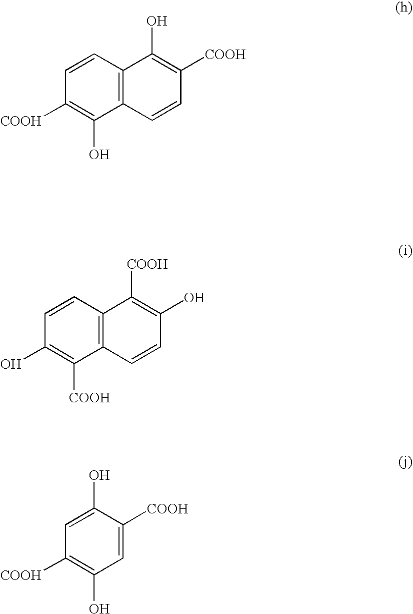

Suitable solvents for method step (a) include cyclic ether, tetrahydrofuran, tetrahydropyran, and mixtures thereof. A cyclic ether is preferred. The dihydroxy diacid is typically added to the solvent with mechanical stirring under an inert atmosphere substantially unreactive with the solvent, aromatic dihydroxy diacid, or other reagents. Suitable inert atmospheres include but are not limited to nitrogen, helium, and noble gases.

Preferably, the concentration of the dihydroxy diacid solution is in the range of 0.05 to 1 mole of diacid per liter of solution. More preferably, the concentration of the resulting dihydroxy diacid solution is in the range of about 0.1 to 0.5 mole of diacid per liter of solution. The addition of the dihydroxy diacid can be performed at a temperature at which the solvent is a liquid. In most cases the temperature is in a range from −5 to 65 degrees Celsius.

Method step (b) comprises contacting the aromatic dihydroxy diacid solution with a halogenating agent. The term “halogenating agent” means a material which reacts with the aromatic dihydroxy diacid to convert the aromatic dihydroxy diacid to the aromatic dihydroxy diacid dihalide. Typical halogenating agents include but are not limited to thionyl chloride, thionyl bromide, phosgene, chlorine, bromine and mixtures thereof. The preferred halogenating agent is thionyl chloride.

The halogenating agent can be added to the solution of the dihydroxy diacid under an inert atmosphere. The halogenating agent can optionally be dissolved in a solvent prior to addition to the dihydroxy diacid solution. Preferably, the optional solvent is the same solvent used in the forming step. If an optional solvent for the halogenating agent is used the solvent should desirably not render the dihydroxy diacid or dihydroxy diacid dihalide insoluble in the combined solvents.

Halogenating agents and dihydroxy diacid dihalides are highly reactive compounds and, their exposure to water can cause undesirable reactions to occur. Therefore, they can be reacted in an environment to minimize exposure to moisture. For example, if the halogenating agent is a liquid, the liquid can be added to the aromatic diacid solution under a dry inert atmosphere such as nitrogen gas. If the halogenating agent is a gas, it can contact the aromatic diacid solution under a substantially inert and low moisture atmosphere to avoid unwanted reactions. Preferably, the halogenating agent is a liquid. Preferably, the halogenating agent is present in a stoichiometric excess based on the amount needed to convert 100 percent of the aromatic dihydroxy diacid to aromatic dihydroxy diacid dihalide.

Step (c) of the method comprises heating the solution of step (b) under an inert atmosphere to convert 50 to 100 percent of the aromatic dihydroxy diacid to aromatic dihydroxy diacid dihalide. The time required for conversion of the aromatic dihydroxy diacid to the aromatic dihydroxy diacid dihalide is less than four hours, preferably, less than two hours, and most preferably, less than one hour. It is believed that a reaction time of at least three minutes is needed in many cases. The solution can be heated to a temperature near the boiling point of the solvent while the solution is stirred mechanically.

Step (d) of the method is the removal of at least a portion of the solvent from the reaction mixture. The reaction mixture can be heated under reduced pressure to remove the solvent by evaporation. Preferably, the removal of the solvent is performed under an inert atmosphere such as nitrogen to limit the ability of the aromatic dihydroxy diacid dihalide to self-polymerize.

Step (d) in removal of all or a portion of the solvent results in formation of a precipitate including the aromatic dihydroxy diacid dihalide as well as undesired compounds to the aromatic dihydroxy diacid dihalide. The undesired compounds can include but are not limited to, unhalogenated aromatic dihydroxy diacid, and mono-halogenated aromatic dihydroxy diacid monohalide, halogenating agent and reacted halogenating agent byproduct.

A more purified form of the aromatic dihydroxy diacid dihalide can be obtained by preferentially dissolving the dihalide in a further solvent. The solvent is chosen such that at least a portion of the undesired materials resulting from step (c) do not dissolve. The temperature is preferentially maintained at a temperature below which the aromatic dihydroxy diacid dihalide will self-polymerize. In most cases the temperature is maintained in the range of 25 to 65 degrees Celsius. Preferably, this temperature is below about 60 degrees Celsius. Insoluble undesired compounds can then be removed for example by filtration. Soluble undesired compounds can then be removed for example by recrystallization. Typical solvents include but are not limited to aliphatic hydrocarbons. Preferably, the solvent includes hexanes, heptanes or mixtures thereof. More preferably, the solvent contains a hexane.

The dihydroxy diacid dihalide can be recovered from the solvent by techniques such as recrystallization, evaporation of the solvent, or fractional distillation. Preferably, the solution of aromatic dihydroxy diacid dihalide in the solvent is cooled to cause the aromatic dihydroxy diacid dihalide to precipitate. A vessel containing the solution is typically cooled in an ice/water bath. The precipitate of aromatic dihydroxy diacid dihalide can then be isolated by for example filtration.

Dihydroxy diacid dihalides are polymerized with aromatic diamines where the term “aromatic diamine” includes compounds of the structure
NH₂-AR—NH₂
where AR are as defined in Ar₁ and Ar₂. The preferred aromatic diamines are paraphenylene diamine or metaphenylene diamine or mixtures thereof, which are shown below by structures (k) and (l) respectively.

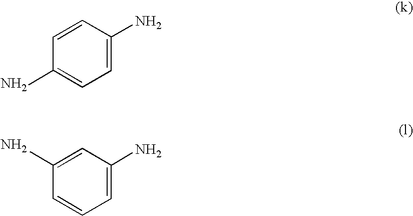

Polymers of this invention are typically prepared from two monomers, one an aromatic diamine and the second an aromatic dihydroxy diacid dihalide. Additionally, if desired co-polymers of this invention can be prepared from three or more monomers. At least one monomer of the co-polymer must consist of an aromatic diamine and at least one monomer of the co-polymer must consist of an aromatic dihydroxy diacid dihalide. Other monomers can be selected to produce co-polymers having a desired set of physical properties. Suitable monomers for the production of co-polymers include but are not limited to p-phenylene diamine, m-phenylene diamine, 4,4′-diphenyldiamine, 3,3′-diphenyldiamine, 3,4′-diphenyldiamine, 4,4′-oxydiphenyldiamine, 3,3′-oxydiphenyldiamine, 3,4′-oxydiphenyldiamine, 4,4′-sulfonyldiphenyldiamine, 3,3′-sulfonyldiphenyldiamine, 4,4′-sulfonyldiphenyldiamine, 3,3′-sulfonyldiphenyldiamine, 3,4′-sulfonyldiphenyldiamine, terephthaloyl chloride, isophthaloyl chloride, 2,6-naphthaloyl chloride, 4,4′-oxydibenzoyl chloride, 3,3′-oxydibenzoyl chloride, 3,4′-oxydibenzoyl chloride, 4,4′-sulfonyldibenzoyl chloride, 3,3′-sulfonyldibenzoyl chloride, 3,4′-sulfonyldibenzoyl chloride, 4,4′-dibenzoyl chloride, 3,3′-dibenzoyl chloride, 3,4′-dibenzoyl chloride, 2-chloro-terephthaloyl chloride, 2-bromo-terephthaloyl chloride, 2,5-dichloro-terephthaloyl chloride, 2,5-dibromo-terephthaloyl chloride, 2-chloro-isophthaloyl chloride, 2-bromo-isophthaloyl chloride, 2,5-dichloro-isophthaloyl chloride, 2,5-dibromo-isophthaloyl chloride, 1,5-dichloro-2,6-naphthaloyl chloride, 1,5-dibromo-2,6-naphthaloyl chloride, 3,7-dichloro-2,6-naphthaloyl chloride, and 3,7-dibromo-2,6-naphthaloyl chloride.

The compressive performance of the polymer with hydroxyl groups incorporated onto the aromatic ring and fibers formed from the polymer is believed to be improved over the compressive performance of a similar polymer without hydroxyl groups. Without being bound to any theory, it is considered that the improvement of compressive performance of polymers and co-polymers comprising the structural repeat unit of this invention is due to hydrogen bonding between the polymer chains due to the hydroxyl groups.

Typically, the polymer repeat units of this invention are considered to be present at least 10 percent of the polymer repeat units of the polymer chain. Preferably, the polymer repeat unit of this invention is present in at least 20 percent of the polymer repeat units of the polymer chain. More preferably, the polymer repeat unit of this invention is present in at least 50 percent of the polymer repeat units of the polymer chain.

General Method:

Polymers and co-polymers of the present invention can be prepared by forming a solution comprising an aromatic diamine monomer and if desired additional diamine monomers in a solvent. The solvent of the solution is typically chosen such that the monomer(s) are soluble in the solvent and the resulting polymer or co-polymer is soluble in the solvent. Typical solvents include but are not limited to sulfuric acid, polyphosphoric acid, n-methylpyrrolidinone, dimethylacetamide, and the like. Preferably, the solvent is sulfuric acid or n-methylpyrrolidinone. The solution is then combined with an aromatic dihydroxy diacid dihalide monomer and if desired additional monomers under conditions such that the monomers will polymerize. The stoichiometry of the monomer(s) is chosen to produce the desired weight percent of the dihydroxy containing repeat units in the resulting polymer or co-polymer.

The first step of the polymer/co-polymer preparation typically comprises forming a solution of a least one aromatic diamine monomer. Suitable solvents include 1-methyl-2-pyrrolidinone, sulfuric acid, polyphosphoric acid, and dimethylacetamide. This can be done by adding the aromatic diamine(s) to the solvent with mechanical stirring under an inert atmosphere. By inert atmosphere it is meant an atmosphere that is essentially unreactive with the solvent, aromatic diamine(s), or other reagents. Suitable inert atmospheres include but are not limited to nitrogen, helium, and noble gases. Preferably, the concentration of the resulting diamine solution is in the range of 0.05 to 1 mole of diamine(s) per liter of solution. More preferably, the concentration of the resulting diamine solution is in the range of about 0.2 to 0.7 mole of diamine(s) per liter of solution. The addition of the diamine(s) is preferably performed at a temperature at which the solvent is a liquid. In most cases the temperature is in the range of −25 to 35 degrees Celsius.

The second step of the method comprises contacting the aromatic diamine(s) solution with one or more aromatic dihydroxy diacid dihalides under an inert atmosphere with mechanical stirring to form a polymer or co-polymer. The aromatic dihydroxy diacid dihalide is added to the diamine solution as a solution, co-crystalline solid, or neat. Typically the aromatic dihydroxy diacid dihalide is added neat or as a co-crystalline solid due to its high reactively. Preferably, the aromatic dihydroxy diacid dihalide is added as a co-crystalline solid. The addition is typically performed at a temperature at which the solvent is a liquid. In most cases the temperature is in the range of −35 to 35 degrees Celsius.

An optional third step of the method comprises contacting the aromatic diamine(s) solution with one or more aromatic diacid or aromatic diacid dihalides which are not hydroxylated to form a co-polymer. The optional third step can be performed before or after the second step. The solution of the monomers is then mechanically stirred while maintaining an inert atmosphere for a time sufficient to allow the monomers to polymerize.

The polymerization reaction can be carried out, for example, under the general conditions described in Man-Made Fibers—Science and Technology, Volume 2, Section titled Fiber-Forming Aromatic Polyamides, page 297, W. Black et al., Interscience Publishers, 1968 and disclosed in U.S. Pat. Nos. 4,172,938; 3,869,429; 3,819,587; 3,673,143; 3,354,127; and 3,094,511.

Polymers of this invention are useful for the production of fibers. Fibers may be spun from solution using any number of processes, however, wet spinning and air-gap spinning are the best known. In wet spinning, the spinneret extrudes the fiber directly into the liquid of a coagulation bath and typically the spinneret is immersed or positioned beneath the surface of the coagulation bath. In air-gap spinning (also sometimes known as “dry-jet” wet spinning) the spinneret extrudes the fiber first into a gas, such as air, for a very short duration and then the fiber is immediately introduced into a liquid coagulation bath. Typically the spinneret is positioned above the surface of the coagulation bath, creating an “air-gap” between the spinneret face and the surface of the coagulation bath. The general arrangement of the spinnerets and baths is well-known in the art, with the figures in U.S. Pat. Nos. 3,227,793; 3,414,645; 3,767,756; 3,869,429; 3,869,430; and 5,667,743 being illustrative of such spinning processes for high strength polymers.

In the following example, all parts and percentages are by weight unless otherwise indicated.

### EXAMPLE

A copolymer was prepared by dissolving 6.785 grams of p-phenylene diamine in 160 grams of a premixed solvent solution of 8.3 weight percent CaCl₂ and 91.7 weight percent 1-methyl-2-pyrrolidinone under a nitrogen atmosphere with mechanical stirring at 20 degrees Celsius. The solution was then cooled to −20 degrees Celsius. To the solution at −20 degrees Celsius was added 2.993 grams of co-crystalline 2,5-dihydroxyterephthaloyl dichloride, 80 percent by weight, and cyclohexane, 20 percent by weight. The mixture was then stirred for 2 minutes until the 2,5-dihydroxyterephthaloyl dichloride was dissolved. To this solution at −20 degrees Celsius was added 10.854 grams of terephthaloyl chloride and the mixture was stirred for 60 seconds. The resulting solution was allowed to warm to 20 degrees Celsius while maintaining a nitrogen atmosphere and continuous mechanical stirring. An inherent viscosity of 3.01 was measured of the resulting co-polymer.

Inherent Viscosity is the ratio of the natural logarithm of the relative viscosity to the mass concentration of the polymer as measured with respect to a solution of 0.5 g of the polymer in 100 ml of concentrated sulfuric acid at 25° C.

What is claimed is:

1. A polymer comprising polymer repeat units of 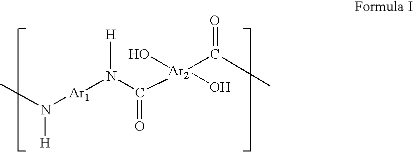
and wherein Ar₁ and Ar₂ independently are aromatic ring systems.

2. The polymer of claim 1 wherein Ar₁ and Ar₂ are identical.

3. The polymer of claim 2 wherein Ar₁ and Ar₂ contain naphthalenic or benzoic groups.

4. The polymer of claim 1 wherein the polymer repeat unit comprises:

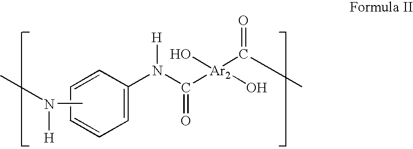

5. The polymer of claim 1 wherein, the polymer repeat unit comprises:

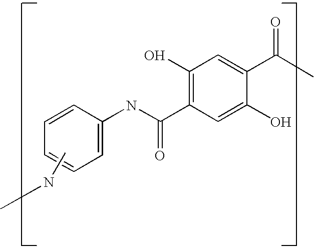

6. The polymer of claim 3 wherein the polymer repeat unit comprises:

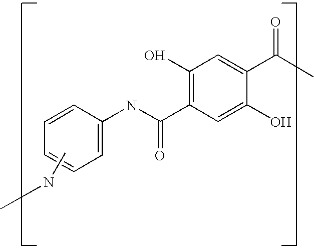

7. The polymer of claim 1 which is a homopolymer.

8. The polymer of claim 1 which is a copolymer.
